(19) United States
(12) Patent Application Publication
(10) Pub. No.: US 2026/0202782 A1
(43) Pub. Date: Jul. 16, 2026

(54) HEATING DEVICE, FIXING DEVICE, AND IMAGE FORMING APPARATUS

(71) Applicants: Yukimichi SOMEYA, Saitama (JP); Yuusuke FURUICHI, Kanagawa (JP)

(72) Inventors: Yukimichi SOMEYA, Saitama (JP); Yuusuke FURUICHI, Kanagawa (JP)

(21) Appl. No.: 19/439,522

(22) Filed: Jan. 5, 2026

(30) Foreign Application Priority Data
Jan. 14, 2025 (JP) 2025-004830

(51) Int. Cl. G03G 15/20; G03G 15/00

(52) U.S. Cl. CPC G03G 15/2053; G03G 15/2064; G03G 15/80; G03G 2215/2025

(57) ABSTRACT

A heating device includes a pressure rotator, a heating rotator, and a heater. The heater includes an electrode, a resistive strip extending in a longitudinal direction of the heater, and an electric conductor. In the longitudinal direction, the resistive strip has a central region having a constant width in a transverse direction and an end region adjacent to the central region, and the end region has a part having a width decreasing in the transverse direction toward an end of the heater in the longitudinal direction and an edge along the part. The electric conductor contacts the edge from one end to another end of the edge in the longitudinal direction and connects the resistive strip and the electrode.

### CROSS-REFERENCE TO RELATED APPLICATIONS

This patent application is based on and claims priority pursuant to 35 U.S.C. § 119(a) to Japanese Patent Application No. 2025-004830, filed on Jan. 14, 2025, in the Japan Patent Office, the entire disclosure of which is hereby incorporated by reference herein.

### BACKGROUND

### Technical Field

The present disclosure relates to a heating device including a resistive strip. In addition, the present disclosure relates to a fixing device and an image forming apparatus that include the heating device.

### Related Art

An image forming apparatus such as a copier or a printer includes a fixing device as an example of a heating device. The fixing device includes a pressure rotator and a heating rotator such as a fixing belt. The pressure rotator and the heating rotator form a nip between the pressure rotator and the heating rotator. A sheet-shaped member to be heated passes through the nip to fix an image onto the sheet-shaped member. The fixing device includes the resistive strip disposed inside the loop of the fixing belt to heat the fixing belt.

### SUMMARY

The present disclosure described herein provides the heating device including a pressure rotator, a heating rotator, and a heater. A sheet passes through the nip in a conveyance direction. The heater is inside the loop of the heating rotator. The heater extends in a longitudinal direction orthogonal to the conveyance direction. The heater includes an electrode, a resistive strip, and an electric conductor. The resistive strip extends in the longitudinal direction. The resistive strip has a central region in the longitudinal direction and an end region adjacent to the central region in the longitudinal direction. The central region has a constant width in a transverse direction orthogonal to the longitudinal direction and parallel to the conveyance direction. The end region has a decreasing part having a width decreasing in the transverse direction toward an end of the heater in the longitudinal direction and an edge along the decreasing part of the end region. The electric conductor is disposed between the resistive strip and the electrode in the longitudinal direction. The electric conductor contacts the edge of the resistive strip from one end to another end of the edge in the longitudinal direction and connects the resistive strip and the electrode.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic diagram illustrating a basic configuration of a fixing device;

FIG. 3A is a plan view of a heater according to a first embodiment;

FIG. 3B is a plan view of a part of a heater according to a comparative example;

FIG. 4 is a cross-sectional view of a part around a fixing nip of the fixing device of FIG. 2;

FIG. 5 is a graph illustrating temperature distributions in fixing belts;

FIG. 6A is a plan view of an end portion of a heater according to a second embodiment;

FIG. 6B is a cross-sectional view of the end portion of the heater of FIG. 6A;

FIG. 7A is a plan view of an end portion of a heater according to a third embodiment;

FIG. 7B is a plan view of an end portion of a heater according to a fourth embodiment;

FIG. 7C is a plan view of an end portion of a heater according to a fifth embodiment;

FIG. 7D is a plan view of an end portion of a heater according to a sixth embodiment;

FIG. 7E is a plan view of an end portion of a heater according to a seventh embodiment;

FIG. 7F is a plan view of a heater according to an eighth embodiment; and

FIG. 8 is a plan view of a heater according to another comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, embodiments of the present disclosure are described below. In the drawings for illustrating embodiments of the present disclosure, identical or similar reference signs are assigned to elements such as components and parts that have identical or similar functions or shapes as far as distinguishable, and descriptions of such elements may be omitted once the description is provided.

An overall configuration of an image forming apparatus is described below.

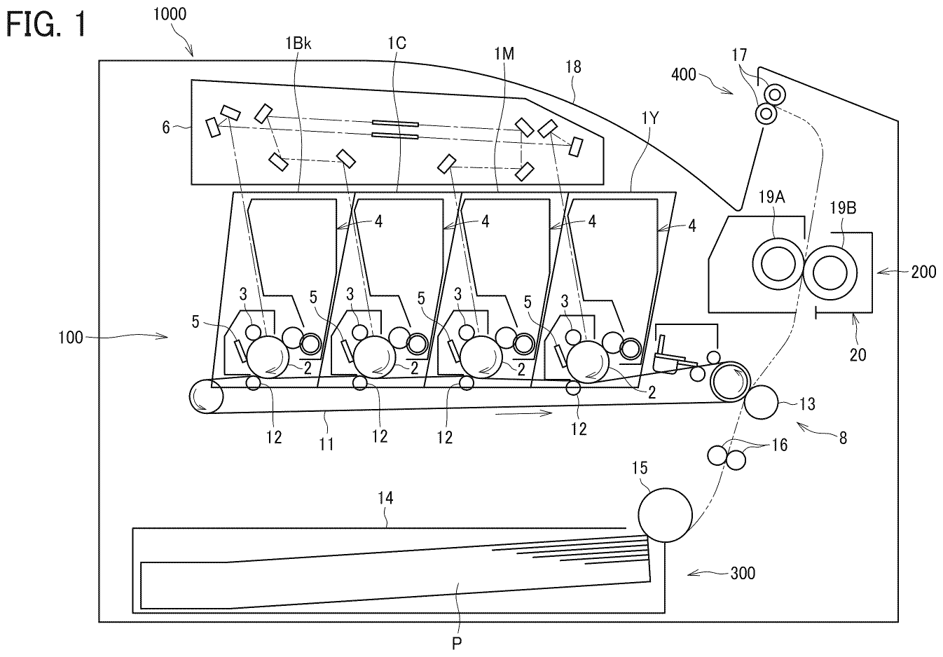

FIG. 1 is a schematic diagram illustrating a configuration of an image forming apparatus 1000. In the following description, the “image forming apparatus” includes a printer, a copier, a facsimile machine, or a multifunction peripheral having at least two of printing, copying, scanning, and facsimile functions.

The term “image formation” used in the following description includes the formation of images with meanings such as characters and figures and the formation of images with no meanings such as patterns. With reference to FIG. 1, a description is given below of the overall configuration and operation of the image forming apparatus 1000. As illustrated in FIG. 1, the image forming apparatus 1000 includes an image forming section 100, a fixing section 200, a sheet feeder 300, and a sheet ejection section 400.

The image forming section 100 is described below.

The image forming section 100 forms an image on a sheet as a recording medium. The image forming section 100 includes four image forming units 1Y, 1M, 1C, and 1Bk, an exposure device 6, and a transfer device 8. Each of the four image forming units 1Y, 1M, 1C, and 1Bk includes a photoconductor 2, a charger 3, a developing device 4, and a cleaner 5.

The photoconductor 2 bears an electrostatic latent image on the surface of the photoconductor 2 and rotates. Examples of the photoconductor 2 includes an endless-shaped photoconductor belt in addition to a drum-shaped photoconductor. The drum-shaped photoconductor 2 is, for example, an inorganic photoconductor such as amorphous silicon or selenium, or an organic photoconductor such as titanyl phthalocyanine.

As the organic photoconductor, there are a laminated photoconductor and a single-layer photoconductor. The laminated photoconductor has a laminated structure containing a layer (a charge generation layer) in which charge-generating materials such as non-metallic phthalocyanine or titanyl phthalocyanine are dispersed in a binder resin and a layer (a charge transport layer) in which charge transport materials are dispersed in a binder resin. These layers are stacked on a support such as an aluminum drum. The single-layer photoconductor has a single-layer structure with a photosensitive layer containing both charge-generating materials and charge transport materials dispersed in a binder resin on a support. In the single-layer photoconductor, it is also possible to add hole transport agents and electron transport agents as charge transport materials to the photosensitive layer. Additionally, the option exists to include an undercoat layer between the support and either the charge-generation layer in the laminated photoconductor or the photosensitive layer in the single-layer photoconductor.

The charger 3 charges the surface of the photoconductor 2. The charging system of the charger 3 is not limited to a particular system as long as the charger 3 applies a voltage to the surface of the photoconductor 2 to uniformly charge the surface of the photoconductor 2. The charging system of the charger 3 can be selected as appropriate depending on the purpose. Specifically, examples of the charger 3 include a contact charger such as a conductive or semiconductive charging roller, a magnetic brush, a fur brush, a film, or a rubber blade, and a non-contact charger using corona discharge.

The developing device 4 supplies toner as the developer to the electrostatic latent image on the photoconductor 2 to form a toner image. The developing devices 4 accommodate toners (developers) of different colors such as yellow, magenta, cyan, and black in the image forming units 1Y, 1M, 1C, and 1Bk, respectively, corresponding to color separation components of a color image.

The cleaner 5 removes the toner and other foreign matters remaining on the photoconductor 2. Examples of the cleaner 5 include a cleaning blade disposed to be in contact with the surface of the photoconductor 2.

The exposure device 6 exposes the charged surface of the photoconductor 2 to form the electrostatic latent image on the surface of the photoconductor 2.

The exposure system of the exposure device 6 is not limited to a particular system as long as the exposure device 6 can expose the charged surface of the photoconductor 2 and can be appropriately selected depending on the purpose. Specific examples of the exposure device include various exposure devices such as a copying optical system, a rod lens array system, a laser optical system, a liquid crystal shutter optical system, and an LED optical system.

The transfer device 8 transfers the toner image onto the sheet. The transfer device 8 includes an intermediate transfer belt 11, primary transfer rollers 12, and a secondary transfer roller 13.

The intermediate transfer belt 11 is an endless belt stretched by a plurality of support rollers. Four primary transfer rollers 12 are disposed inside the loop of the intermediate transfer belt 11.

Each of the primary transfer rollers 12 is in contact with the corresponding photoconductor 2 via the intermediate transfer belt 11 to form a primary transfer nip between the intermediate transfer belt 11 and each photoconductor 2. The secondary transfer roller 13 is in contact with the outer circumferential surface of the intermediate transfer belt 11. Thus, the secondary transfer nip is formed between the secondary transfer roller 13 and the intermediate transfer belt 11.

An elastic intermediate transfer belt may be used as the intermediate transfer belt 11. The elastic intermediate transfer belt may include, for example, a rigid base layer having relatively flexibility and a flexible elastic layer layered on the base layer. In addition, the intermediate transfer belt 11 may include a guide on the inner circumferential surface of the intermediate transfer belt to prevent the intermediate transfer belt 11 from meandering.

The fixing section 200 is described below.

The fixing section 200 includes a fixing device 20 that heats the sheet to fix the image on the sheet. The fixing device 20 includes a pair of first and second rotators 19A and 19B contacting each other and a heater heating at least one of the pair of first and second rotators 19A and 19B.

The sheet feeder 300 is described below.

The sheet feeder 300 supplies the sheet to the image forming section 100. The sheet feeder 300 includes a sheet tray 14 to store sheets P as heated members and a feed roller 15 to feed the sheet P from the sheet tray 14. Thus, the secondary transfer nip is formed between the secondary transfer roller 13 and the intermediate transfer belt 11.

Examples of the “heated member” that are sheets include not only a sheet of paper but also an overhead projector (OHP) transparency sheet, a fabric, a metallic sheet, a plastic film, and a prepreg sheet including carbon fibers previously impregnated with resin. Examples of the “sheet” further include thick paper, a postcard, an envelope, thin paper, coated paper (e.g., coat paper and art paper), and tracing paper, in addition to plain paper.

The sheet ejection section 400 is described below.

The sheet ejection section 400 ejects the sheet P to the outside of the image forming apparatus 1000. The sheet ejection section 400 includes an output roller pair 17 to eject the sheet P to the outside of the image forming apparatus 1000 and an output tray 18 to place the sheet P ejected by the output roller pair 17.

An image forming operation is described below.

With continued reference to FIG. 1, the image forming operation of the image forming apparatus 1000 is described below. The image forming operation is started in response to an instruction from an operation panel or external terminals. In each of the image forming units 1Y, 1M, 1C, and 1Bk, the photoconductor 2 starts rotating.

Subsequently, the charger 3 uniformly charges the surface of the photoconductor 2 to a high electric potential. Based on image data of a document read by a document reading device or print data instructed to print by a terminal, the exposure device 6 exposes the charged surface of each of the photoconductors 2.

As a result, the electric potential at an exposed portion on the surface of each of the photoconductors 2 is decreased. Thus, the electrostatic latent image is formed on the surface of each of the photoconductors 2. The developing devices 4 supply toners to the photoconductors 2, respectively, to form toner images of different colors on the photoconductors 2, respectively.

As the photoconductors 2 rotate, the toner images on the photoconductors 2 reach primary transfer nips defined by the positions of the primary transfer rollers 12, respectively. At the primary transfer nips, the toner images are transferred from the photoconductors 2 onto the intermediate transfer belt 11 driven to rotate so as to be sequentially superimposed on one another.

Thus, the full-color toner image is formed on the intermediate transfer belt 11. The image forming operation is not limited to the above-described full color image forming operation that uses all four image forming units 1Y, 1M, 1C, and 1Bk. Alternatively, the image forming apparatus 1000 can form a monochrome toner image by using any one of the four image forming units 1Y, 1M, 1C, and 1Bk, or can form a bicolor toner image or a tricolor toner image by using two or three of the image forming units 1Y, 1M, 1C, and 1Bk.

After the toner image is transferred to the intermediate transfer belt 11, the cleaner 5 removes residual toner remaining on the photoconductor 2 from the surface of the photoconductor 2. As a result, the cleaner 5 removes foreign matter such as residual toner on the photoconductor 2.

The full-color toner image transferred to the intermediate transfer belt 11 is conveyed to the secondary transfer nip defined by the secondary transfer roller 13 in accordance with rotation of the intermediate transfer belt 11. At the secondary transfer nip, the full-color toner image is transferred from the intermediate transfer belt 11 onto the sheet P.

The sheet P is fed from the sheet feeder 300. After the start of the image forming operation, the feed roller 15 rotates to feed the sheet P from the sheet tray 14.

Before the sheet P reaches the secondary transfer nip, the sheet P fed from the sheet tray 14 is brought into contact with a timing roller pair 16 and temporarily stopped. After the sheet P is temporarily stopped, the timing roller pair 16 is rotated at a predetermined time to convey the sheet P to the secondary transfer nip in synchronization with the full-color toner image formed on the intermediate transfer belt 11 reaching the secondary transfer nip. As a result, the full-color toner image is transferred to the sheet P.

The sheet P bearing the full-color toner image is conveyed to the fixing section 200. In the fixing section 200, the sheet P passes between the pair of first and second rotators 19A and 19B, and thus the full-color toner image on the sheet P is heated and pressed to fix the full-color toner image to the sheet P.

Then, the sheet P bearing the fixed toner image is conveyed to the sheet ejection section 400. In the sheet ejection section 400, the output roller pair 17 ejects the sheet P onto the output tray 18. Thus, a series of image forming operations is completed.

The basic configuration of the fixing device 20 is described below.

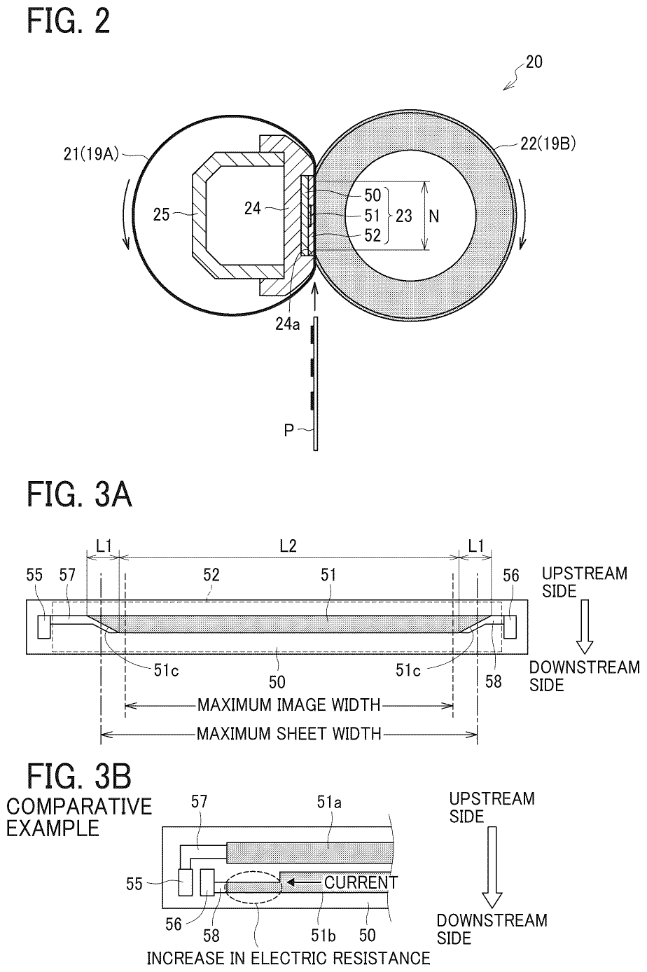

FIG. 2 is a schematic diagram illustrating the basic configuration of the fixing device 20. As illustrated in FIG. 2, the fixing device 20 includes a heater 23, a heater holder 24, and a stay 25 in addition to the pair of first and second rotators 19A and 19B.

The first rotator 19A is a fixing belt 21 disposed to contact an unfixed toner image on a surface of the sheet P. The fixing belt 21 is an example of a heating rotator. The second rotator 19B is a pressure roller 22 disposed to face the fixing belt 21. The pressure roller 22 is an example of a pressure rotator.

A pressure member such as a spring presses the fixing belt 21 and the pressure roller 22 to be in contact with each other. As a result, a fixing nip N is formed between the fixing belt 21 and the pressure roller 22.

The fixing belt 21 is an endless belt including a tubular base and a release layer on an outer circumferential surface of the base. The base is made of metal such as nickel or stainless steel or resin such as polyimide.

The release layer is made of, for example, tetrafluoroethylene-perfluoroalkylvinylether copolymer (PFA), polytetrafluoroethylene (PTFE), polyimide, polyetherimide, or polyether sulfide (PES). The release layer of the fixing belt 21 facilitates the separation of toner contained in the toner image from the fixing belt 21 and prevents the sheet P from adhering to and wrapping around the fixing belt 21.

The fixing belt 21 may include an elastic layer between the base and the release layer. Examples of the material of the elastic layer include rubber such as silicone rubber, silicone rubber foam, and fluororubber. The elastic layer of the fixing belt 21 prevents the fixing belt 21 from forming slight surface asperities, thus facilitating uniform conduction of heat to the toner image on the sheet P to enhance fixing quality.

The pressure roller 22 includes a solid or hollow cored bar, an elastic layer on the outer circumferential surface of the cored bar, and a release layer on the outer circumferential surface of the elastic layer. The cored bar is made of metal such as iron.

Examples of the material of the elastic layer include silicone rubber, silicone rubber foam, and fluororubber. The release layer is made of fluororesin such as PFA or PTFE.

The heater 23 heats the fixing belt 21. The heater 23 is disposed inside the loop of the fixing belt 21 as the heating rotator. The heater 23 has a plate shape or a planar shape and contacts the inner circumferential surface of the fixing belt 21.

At a position where the fixing belt 21 faces the pressure roller 22, the heater 23 contacts the inner circumferential surface of the fixing belt 21 to form the fixing nip N between the fixing belt 21 and the pressure roller 22. The heater 23 may be in direct contact with the inner circumferential surface of the fixing belt 21 or may be in indirect contact with the inner circumferential surface of the fixing belt 21 via a low-friction slide sheet. In the present specification, unless otherwise specified, the meaning of “contact” includes direct contact and indirect contact. In the direct contact, a first member is in contact with a second member via no member. In the indirect contact, a third member is in contact with a fourth member via a fifth member.

Specifically, the heater 23 includes a base 50, a resistive strip 51, and an insulation layer 52. The resistive strip 51 is disposed on the base 50 and covered with the insulation layer 52.

When power is supplied to the resistive strip 51, the resistive strip 51 generates heat. The heat is transferred to the inner circumferential surface of the fixing belt 21 via the insulation layer 52 to heat the fixing belt 21. Alternatively, the heater 23 may be turned inside out so that the base 50 is in contact with the inner circumferential surface of the fixing belt 21. In this case, since the heat of the resistive strip 51 is transmitted to the fixing belt 21 through the base 50, it is preferable that the base 50 be made of a material with high thermal conductivity.

The base 50 is made of material having heat resistance and insulation properties, such as ceramic such as alumina or aluminum nitride, or non-metal material such as glass or mica. Interposing another insulation layer between the base 50 and the resistive strip 51 enables using conductive material such as metal as the material of the base 50.

Low-cost aluminum or stainless steel is favorable as the metal material of the base 50.

To reduce the temperature unevenness of the heater 23 and enhance image quality, the base 50 may be made of material having high thermal conductivity, such as copper, graphite, or graphene. Graphene is formed by bonding of carbon atoms and has a sheet shape.

The resistive strip 51 is formed by, for example, screen-printing. The resistive strip 51 is produced by, for example, mixing silver-palladium (AgPd) and glass powder into a paste. The paste is coated on the base 50 by screen printing. Subsequently, the base 50 is fired to form the resistive strip 51.

The material of the resistive strip 51 may contain a resistance material, such as silver alloy (e.g., AgPt) or ruthenium oxide (RuO₂) in addition to silver-palladium. The insulation layer 52 may be made of, for example, heat-resistant glass.

The heater holder 24 holds the heater 23. The heater holder 24 accommodates the heater 23 in a recess 24a to restrict the movement of the heater 23 in the vertical direction in FIG. 2 and the direction orthogonal to the paper surface in which FIG. 2 is drawn.

Since the heater holder 24 is heated to a high temperature by heat from the heater 23, the heater holder 24 is preferably made of a heat resistant material. In particular, the heater holder 24 made of heat-resistant resin having low thermal conduction, such as a liquid crystal polymer (LCP), reduces unnecessary heat transfer from the heater 23 to the heater holder 24, thus increasing the heating efficiency of the heater 23.

The stay 25 supports the heater holder 24. The stay 25 supports a stay side face of the heater holder 24. The stay side face is opposite a nip side face of the heater holder 24. The nip side face faces the pressure roller 22. Accordingly, the stay 25 prevents the heater 23 from being bent by a pressing force of the pressure roller 22. As a result, the fixing nip N having a uniform width is formed between the fixing belt 21 and the pressure roller 22. The stay 25 is preferably made of iron-based metal such as steel use stainless (SUS) or steel electrolytic cold commercial (SECC) to enhance the rigidity.

The following describes the operation of the fixing device 20.

The fixing device 20 operates as follows. When the image forming operation starts, a driver starts driving to rotate the pressure roller 22 in a direction indicated by an arrow in FIG. 2, and the rotation of the pressure roller 22 rotates the fixing belt 21. A power source starts supplying power to the heater 23, and the heater 23 generates heat to heat the fixing belt 21.

After the temperature of the fixing belt 21 reaches a specified target temperature, the sheet P bearing the unfixed image is conveyed to the fixing nip N between the fixing belt 21 and the pressure roller 22. As a result, the unfixed toner image on the sheet P is heated and pressed to be fixed on the sheet P. The sheet P is ejected from the fixing nip N and conveyed to the sheet ejection section 400.

A heater configuration is described below.

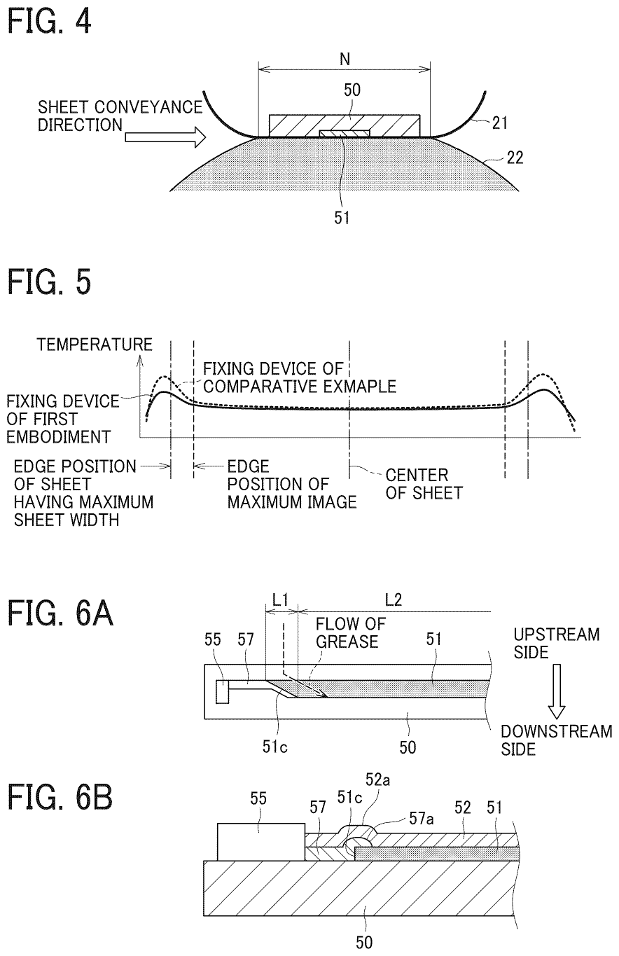

FIG. 3A is a plan view of a basic configuration of the heater 23 according to a first embodiment. FIG. 4 is a schematic cross-sectional view of a part around the fixing nip in FIG. 2. As illustrated in FIGS. 3A and 4, the heater 23 includes a pair of end electrodes 55 and 56 to supply power to the resistive strip 51 and multiple electric conductors 57 and 58 in addition to the base 50, the resistive strip 51, and the insulation layer 52.

The base 50 is a longitudinal plate arranged to extend in the longitudinal direction X of the fixing belt 21. The resistive strip 51 is on the base 50 and extends in the longitudinal direction (that is the X direction) of the base 50.

The pair of end electrodes 55 and 56 are at the ends of the base 50 in the longitudinal direction. The end electrodes 55 and 56 are connected to the resistive strip 51 via the multiple electric conductors 57 and 58.

The arrangement, number, shape of each of the resistive strip 51, the end electrodes 55 and 56, and the electric conductors 57 and 58 are not limited to the example illustrated in FIG. 3A and may be appropriately changed.

The electric conductors 57 and 58 are covered with the insulation layer 52 in the same manner as the resistive strip 51 in order to obtain insulation and durability. However, the insulation layer 52 does not cover the end electrodes 55 and 56 to expose the end electrodes 55 and 56 as power supply terminals so as to be connected to the connectors. Connecting the connectors to the end electrodes 55 and 56 enables the power source (an alternating-current (AC) power source) disposed in the body of the image forming apparatus to supply power to the resistive strip 51.

In the following description, a transverse direction is defined as a direction parallel to a conveyance direction in which the sheet P passes through the fixing nip, and the longitudinal direction is defined as a direction orthogonal to the transverse direction. The resistive strip 51 has end regions L1 and a central region L2 that is adjacent to the end regions L1 in the longitudinal direction. In the central region L2, the resistive strip 51 has a constant width in the transverse direction. In the end region L1, the resistive strip 51 has a width in the transverse direction decreasing toward the end of the heater 23 in the longitudinal direction. The closer a position on the resistive strip 51 in the end region L1 is to the end of the heater 23 in the longitudinal direction, the smaller the width of the resistive strip 51 in the transverse direction at that position.

In the end region L1 having the width in the transverse direction decreasing toward the end of the heater 23, the electric conductor 57 is connected to the entire edge 51c of the resistive strip 51. Specifically, the width of the end regions L1 in the transverse direction linearly decreases toward the end of the heater 23 in the longitudinal direction. In other words, the end region L1 has a decreasing part having the width in the transverse direction decreasing toward the end of the heater 23 in the longitudinal direction and the edge 51c along the decreasing part of the end region L1, and the edge 51c has a straight line shape.

In FIG. 3A, a downstream portion of the edge 51c of the resistive strip 51 in the conveyance direction is closer to the center of the resistive strip 51 in the longitudinal direction than an upstream portion of the edge 51c in the conveyance direction. In other words, the edge 51c has one end and another end in the longitudinal direction, the one end is upstream from said another end in the conveyance direction, and said another end is closer to the center of the resistive strip 51 than the one end in the longitudinal direction. In the above description, the expression “the electric conductor 57 is connected to the entire edge 51c” means that the electric conductor 57 is continuously connected from the upstream end to the downstream end of the edge 51c in the conveyance direction. In other words, the expression “the electric conductor 57 is connected to the entire edge 51c” means that the electric conductor 57 contacts the edge 51c of the resistive strip 51 from one end to another end of the edge 51c in the longitudinal direction. Note that, unlike FIG. 3A, an upstream portion of the edge 51c of the resistive strip 51 in the conveyance direction may be closer to the center of the resistive strip 51 in the longitudinal direction than a downstream portion of the edge 51c in the conveyance direction.

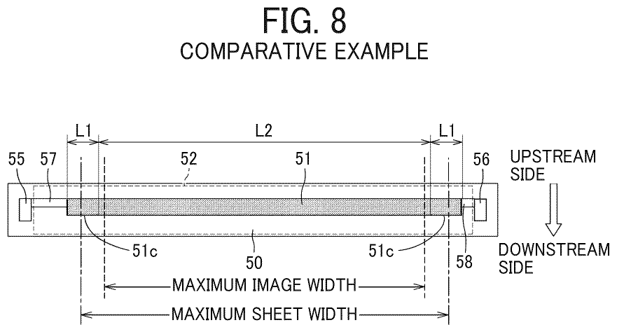

Forming the edge 51c of the resistive strip 51 to be inclined and connecting the electric conductor 57 to the entire edge 51c as described above gradually decreases the amount of heat generated by the end region L1 toward the end of the resistive strip 51 in the longitudinal direction. Since the electric conductor 57 is connected to the entire edge 51c of the resistive strip 51, the electric resistance does not increase in the end region L1. As a result, as illustrated in FIG. 5, the excessive temperature rise in the non-sheet-passing region of the fixing belt 21 in the fixing device 20 can be reduced to be smaller than the excessive temperature rise in the non-sheet-passing region of the fixing belt in a fixing device of a comparative example illustrated in FIG. 8.

According to the present embodiment, the cost can be reduced without increasing the material of the resistive strip 51. In addition, damage to the components of the fixing device 20 and the lubricant (grease) can be prevented.

In the longitudinal direction, the width of the resistive strip 51 in the transverse direction decreases in a range from a position outside the maximum image to a position facing an edge of the maximum sheet. In other words, the end region L1 faces an edge of the maximum sheet having the maximum width of the widths, in the longitudinal direction, of sheets passable in the fixing device 20. The heater 23 configured as described above can sufficiently heat a part of the fixing belt that contacts an end portion of the unfixed toner image in the longitudinal direction even when the heater 23 starts heating the fixing belt, which prevents the occurrence of a fixing failure. In addition, the temperature rise in the non-sheet-passing region can be reduced.

Typically, narrowing the width of the resistive strip 51 in the transverse direction at any position in the longitudinal direction of the heater that is a direction of a current flow increases the resistance value per unit length in the longitudinal direction and the amount of heat generation. However, since the electric conductor 57 is in contact with the entire edge 51c that forms a portion gradually reducing the width of the resistive strip 51 in the transverse direction, the resistance value does not change at any position in the longitudinal direction of the resistive strip 51 through which current flows. Accordingly, the amount of heat generation does not change at any position in the longitudinal direction of the resistive strip 51, and the resistive strip 51 generates heat according to the cross-sectional area in the transverse direction at any position in the longitudinal direction of the resistive strip 51.

The amount of heat generation decreases as the area (the cross-sectional area) of the resistive strip 51 decreases toward the end of the resistive strip 51. Setting the amount of heat generation at the end portions of the resistive strip 51 to be smaller than that at the center can reduce the temperature rise in the non-sheet-passing region.

With reference to FIG. 3B, the comparative example is described below. The heater according to the comparative example includes the electric conductor 58 disposed on an end portion of the heater and a resistive strip 51b including a narrow portion that extends from a position away from the electric conductor 58 to the edge of the electric conductor 58 and has a constant narrow width. In this case, the amount of heat generated by the narrow portion is larger than the amount of heat generated by the center of the heater in the longitudinal direction. Simply reducing the width (the cross-sectional area) of the resistive strip 51b in the transverse direction in the end region L1 increases the electric resistance of the resistive strip 51b in the end region L1 and locally increases the amount of heat generation. As a result, in the heater configured as illustrated in FIG. 3B, preventing the excessive temperature rise in the non-sheet-passing region of the fixing belt 21 is difficult.

FIG. 6A is a plan view of an end portion of a heater according to a second embodiment, and FIG. 6B is a cross-sectional view of the end portion of the heater of FIG. 6A. The cross-sectional view of FIG. 6B illustrates a connection portion between the electric conductor 57 and the edge 51c of the resistive strip 51.

In the heater 23, the electric conductor 57 is stacked on the resistive strip 51 in the thickness direction to enhance stable energization, and the insulation layer 52 is disposed on the resistive strip 51 and the electric conductor 57. The above-described structure forms a convex shape of a contact portion between the resistive strip 51 and the electric conductor 57.

In other words, the end portion of the electric conductor 57 connected to the edge 51c of the resistive strip 51 covers the edge 51c of the resistive strip 51. The electric conductor 57 has a conductor end contacting the edge 51c of the resistive strip 51, and the conductor end covers the edge 51c of the resistive strip 51 and projects toward the pressure rotator 22. As a result, the end portion of the electric conductor 57 forms a projection 57a projecting upward (in other words, toward the pressure roller 22). The projection 57a causes the insulation layer 52 to form a projection 52a projecting upward (in other words, toward the pressure roller 22). The projection 52a is formed so that a downstream portion of the projection 52a in the conveyance direction is closer to the center of the heater in the longitudinal direction than an upstream portion of the projection 52a in the conveyance direction.

Lubricant (grease) is applied to the inner surface of the fixing belt 21 to reduce an increase in sliding wear with the heater 23 and an increase in driving torque of the fixing belt 21. The movement of the fixing belt 21 from the upstream side to the downstream side conveys the grease applied to the inner surface of the fixing belt 21 to the downstream side.

Most of the grease conveyed to the fixing nip stays on the upstream side of the fixing nip without entering the fixing nip. Such an excessive grease staying on the upstream side of the fixing nip may flow out to the outside of the fixing nip in the longitudinal direction and may not be effectively used.

The projection 52a of the insulation layer 52 inclined toward the center of the fixing nip in the longitudinal direction from the upstream side to the downstream side in the conveyance direction as illustrated in FIG. 6A guides the excessive grease staying on the upstream side of the fixing nip toward the center of the fixing nip. As a result, the grease is effectively used as the lubricant.

The grease can prevent the abrasion of the fixing belt 21 and the increase in the torque for a long period of time.

Other embodiments are described below.

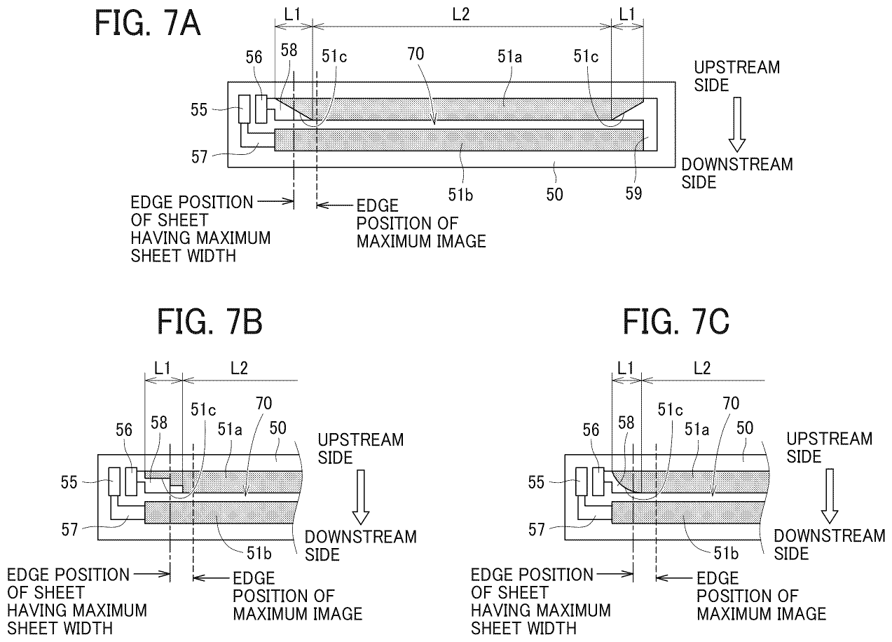

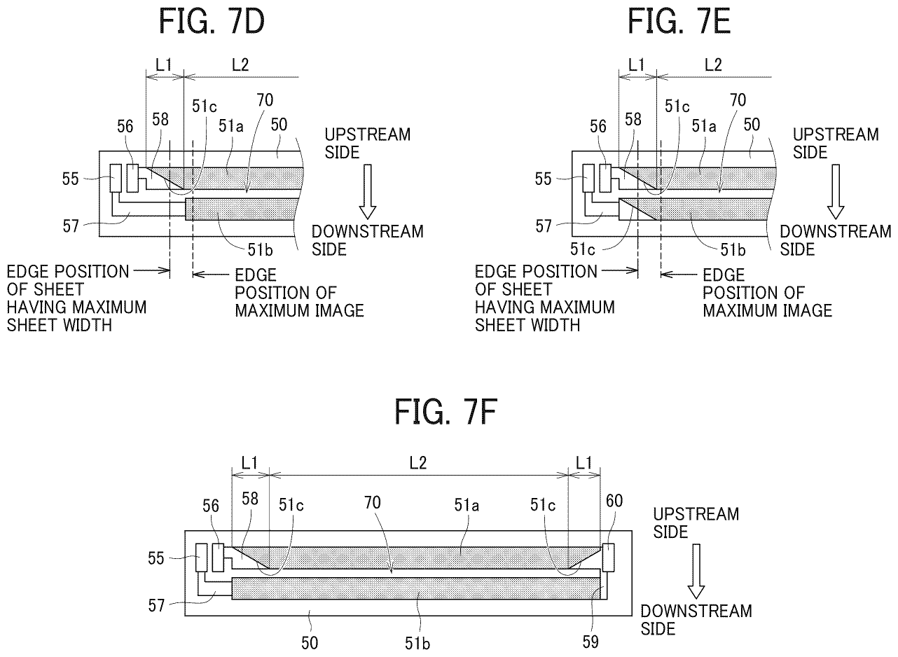

FIGS. 7A to 7F are plan views of heaters according to third to eighth embodiments. As illustrated in FIG. 7A, the heater according to the third embodiment includes resistive strips 51a and 51b arrayed in two rows. The upstream resistive strip 51a has the end regions L1 and the central region L2.

The downstream resistive strip 51b extends in the longitudinal direction and has a constant width in the transverse direction over the entire length thereof. The heater may include three or more rows (multiple rows) of the resistive strips.

The two rows of the resistive strips 51a and 51b increase a heat generation area. Increasing the heat generation area increases a time to heat the fixing belt 21, which increases a heat transfer rate. One row of the resistive strip that can give the same amount of heat given by two rows of the resistive strips needs to have a narrow width, but multiple rows of the resistive strips enable each resistive strip to have a wide width in the transverse direction and increase the time to heat the fixing belt. As a result, the heat transfer rate is increased.

The left end of the resistive strips 51a is connected to the end electrode 56 via the electric conductor 58, and the left end of the resistive strip 51b is connected to the end electrode 55 via the electric conductor 57. The right ends of the resistive strips 51a and 51b are connected in series to each other by an electric conductor 59.

A gap 70 formed between the two rows of the resistive strips 51a and 51b has a constant width in the transverse direction over the entire length in the longitudinal direction. The above-described configuration can uniform the amount of heat generation in the longitudinal direction in the central region L2 and give a uniform and stable fixing performance.

The gap 70 is preferably 0.2 mm or more, more preferably 0.4 mm or more from the viewpoint of maintaining the insulation between the resistive strips 51a and 51b. In addition, the gap 70 is preferably 5 mm or less, and is more preferably 1 mm or less, from the viewpoint of reducing temperature unevenness in the longitudinal direction because a too large gap 70 easily causes a temperature drop corresponding to the gap 70.

The gap 70 may be positioned at the center of the nip width of the fixing nip N in the transverse direction that is the pressure center of the pressure roller 22 in the transverse direction. The above-described configuration can give uniform fixing performance on both sides of the nip width.

As illustrated in FIG. 7B, the heater according to the fourth embodiment includes the upstream resistive strip 51a having the edge 51c, and the edge 51c is formed so that the widths of the resistive strip 51a in the end region L1 in the transverse direction decrease stepwise toward the longitudinal end of the resistive strip 51a. As illustrated in FIG. 7C, the heater according to the fifth embodiment includes the upstream resistive strip 51a having the edge 51c, and the edge 51c is formed so that the widths of the resistive strip 51a in the end region L1 in the transverse direction decrease in an arc shape toward the longitudinal end of the resistive strip 51a. In other words, the end region L1 may have at least one of a straight line shape, a stepwise shape, or an arc shape.

As illustrated in FIG. 7D, the heater according to the sixth embodiment includes the upstream resistive strip 51a having the edge 51c, and the edge 51c is formed so that the widths of the resistive strip 51a in the end region L1 in the transverse direction linearly decrease toward the longitudinal end of the resistive strip 51a. In other words, the edge 51c has a straight line shape. The downstream resistive strip 51b extends in the longitudinal direction and has a constant width in the transverse direction over the entire length thereof. Since the electric conductor 57 is located on a downstream portion of the heater in the end region L1, the downstream resistive strip 51b does not transmit heat to this portion. The above-described configuration can reduce the amount of heat in the end region L1.

As illustrated in FIG. 7E, the heater according to the seventh embodiment includes the upstream resistive strip 51a and the downstream resistive strip 51b each having the edge 51c, and the edge 51c is formed so that the widths of the resistive strip 51a in the end region L1 in the transverse direction linearly decrease toward the longitudinal end of the resistive strip 51a. The inclination of the edge 51c may be the same or different between the upstream resistive strip 51a and the downstream resistive strip 51b.

As illustrated in FIG. 7F, the heater according to the eighth embodiment includes the upstream resistive strip 51a having the edges 51c, and each of the edges 51c is formed so that the widths of the resistive strip 51a in the end region L1 in the transverse direction linearly decrease toward the longitudinal end of the resistive strip 51a. Additionally, the right ends of the upstream resistive strip 51a and the downstream resistive strip 51b are connected to an end electrode 60 via the electric conductor 59. The above-described configuration enables a controller to independently control the temperatures of the upstream and downstream resistive strips 51a and 51b.

In the transverse direction, the positions of the longitudinal ends of the downstream resistive strip 51b are the same as the position of the downstream portion of the electric conductor 59 in FIG. 7F. The above-described configuration can prevent the occurrence of the temperature drop in a portion of the fixing belt 21 corresponding to the electric conductor 59 (in other words, the temperature drop in the end portions of the fixing belt 21).

The present disclosure has been described above on the basis of the embodiments, but the present disclosure is not limited to the embodiments. Needless to say, various alterations can be made in the scope of the technical idea described in the scope of the claims.

The following describes preferred aspects of the present disclosure.

### First Aspect

In a first aspect, the heating device has the following features. The heating device includes a pressure rotator, a heating rotator, a resistive strip, electric conductors, and electrodes to supply power to the resistive strip. A nip is formed between the pressure rotator and the heating rotator. A heated member having a sheet shape passes through the nip in a conveyance direction. A transverse direction is defined as the same direction as the conveyance direction, and a longitudinal direction is defined as a direction orthogonal to the transverse direction. The resistive strip is disposed inside a loop of the heating rotator and extends in the longitudinal direction. Additionally, both ends of the resistive strip are connected to the electrodes via conductors. In the longitudinal direction, the resistive strip has a central region and an end region adjacent to the central region. In the central region, the resistive strip has a constant width in the transverse direction. In the end region, the resistive strip has a portion having the width in the transverse direction that decreases toward an end of the resistive strip in the longitudinal direction. The electric conductor is connected to the entire edge of the portion.

### Second Aspect

In a second aspect, the heating device according to the first aspect is characterized in that the edge of the resistive strip to which the electric conductor is connected is formed so that a point on the edge is closer to the center of the resistive strip in the longitudinal direction than another point on the edge upstream from the point in the conveyance direction.

### Third Aspect

In a third aspect, the heating device according to the first aspect or the second aspect is characterized in that the electric conductor has an end portion connected to the edge of the resistive strip, and the end portion covers the edge of the resistive strip to form a projection projecting toward the pressure rotator.

### Fourth Aspect

In a fourth aspect, the heating device according to any one of the first to third aspects is characterized in that the end region is formed inside a sheet-passing region of the heated member.

### Fifth Aspect

In a fifth aspect, the heating device according to any one of the first to fourth aspects is characterized in that the heating device includes multiple resistive strips including the resistive strip and arranged in multiple rows, and at least one of the multiple resistive strips has the central region and the end region.

### Sixth Aspect

In a sixth aspect, the heating device according to the fifth aspect is characterized in that each of the multiple resistive strips has both ends each connected to the electrode via the electric conductor.

### Seventh Aspect

In a seventh aspect, the heating device according to the fifth aspect or the sixth aspect is characterized in that a gap having a constant width in the short direction is formed between multiple rows of the resistive strips in the central region.

### Eighth Aspect

In an eighth aspect, the heating device according to any one of the first to seventh aspects is characterized in that the width of the end region in the transverse direction decreases linearly, stepwise, or in an arc shape toward the end of the resistive strip in the longitudinal direction.

### Ninth Aspect

In a ninth aspect, a fixing device includes the heating device according to any one of the first to eighth aspects.

### Tenth Aspect

In a tenth aspect, an image forming apparatus includes the fixing device according to the ninth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A heating device comprising:
a pressure rotator;
a heating rotator:
having a loop; and
forming a nip between the pressure rotator and the heating rotator, the nip through which a sheet passes in a conveyance direction; and
a heater:
inside the loop of the heating rotator; and
extending in a longitudinal direction orthogonal to the conveyance direction,
wherein the heater includes:
an electrode;
a resistive strip extending in the longitudinal direction,
the resistive strip has:
a central region in the longitudinal direction,
the central region having a constant width in a transverse direction orthogonal to the longitudinal direction and parallel to the conveyance direction; and
an end region adjacent to the central region in the longitudinal direction,
the end region having:
a decreasing part having a width decreasing in the transverse direction toward an end of the heater in the longitudinal direction; and
an edge along the decreasing part of the end region; and
an electric conductor disposed between the resistive strip and the electrode in the longitudinal direction,
the electric conductor:
contacting the edge of the resistive strip from one end to another end of the edge in the longitudinal direction; and
connecting the resistive strip and the electrode.

2. The heating device according to claim 1,
wherein the one end of the edge is upstream from said another end of the edge in the conveyance direction, and said another end is closer to a center of the resistive strip than the one end in the longitudinal direction.

3. The heating device according to claim 1,
wherein the electric conductor has a conductor end contacting the edge of the resistive strip,
the conductor end:
covers the edge of the resistive strip; and
projects toward the pressure rotator.

4. The heating device according to claim 1,
wherein the sheet has a maximum width among widths of sheets passable through the heating device, and
the end region faces an edge of the sheet in the longitudinal direction.

5. The heating device according to claim 1, further comprising
multiple resistive strips including the resistive strip, the multiple resistive strips arrayed in multiple rows in the conveyance direction.

6. The heating device according to claim 5, further comprising:
multiple electric conductors including the electric conductor; and
multiple electrodes including the electrode,
wherein each of the multiple resistive strips has both ends, and each of the ends is connected to one of the multiple electrodes via one of the multiple electric conductors.

7. The heating device according to claim 5,
wherein the multiple resistive strips form a gap in the central region, and the gap has a constant width in the transverse direction.

8. The heating device according to claim 1,
wherein the end region has at least one of a straight line shape, a stepwise shape, or an arc shape.

9. A fixing device comprising the heating device according to claim 1.

10. An image forming apparatus comprising the fixing device according to claim 9.
